(19) United States
(12) Patent Application Publication
(10) Pub. No.: US 2008/0284701 A1
(43) Pub. Date: Nov. 20, 2008

(54) METHOD FOR DRIVING LIQUID CRYSTAL DISPLAY

(75) Inventors: Kuan-Hsu Fan-Chiang, Tainan County (TW); Bing-Jei Liao, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HIMAX DISPLAY, INC., Tainan County (TW)

(21) Appl. No.: 11/850,670

(22) Filed: Sep. 5, 2007

(30) Foreign Application Priority Data
May 17, 2007 (TW) 96117571

(51) Int. Cl. G09G 3/36

(52) U.S. Cl. 345/90

(57) ABSTRACT

A method for driving a liquid crystal display is provided. The method includes: turning on a display-enable switch to pass through time of liquid crystal response and light display of a first frame until a reset time appeared. At the same time, turn on a second write-enable switch to pre-deliver a pixel signal corresponding to a second frame to a second storage capacitor. During reset time of the first frame time, turn on a reset switch and provide a reset voltage signal to a pixel electrode while the first and the second display-enable switches and the first and the second write-enable switches are turned off, in which the reset voltage signal has a first voltage level during a first period, and a second voltage level in a second period. Therefore, the method can increase brightness of the display, and decrease image sticking effect thereof.

### CROSS-REFERENCE TO RELATED APPLICATION

This application claims the priority benefit of Taiwan application serial no. 96117571, filed May 17, 2007. All disclosure of the Taiwan application is incorporated herein by reference.

### BACKGROUND OF THE INVENTION

1. Field of the Invention

The present invention relates to a method for driving a display, and more particularly to a method for driving a liquid crystal display.

2. Description of Related Art

Color sequential displays have the advantages of high brightness, high resolution, and high chroma, and uses light emitting diodes (LEDs) as a light source to achieve the purpose of reduced volume and light weight. However, in order to make the images of red (R), green (G), and blue (B) overlapped to mix colors, liquid crystals with a quick response speed or a liquid crystal layer with a smaller thickness is required in processes to improve the response speed of the liquid crystal.

FIG. 1 is a driving circuit diagram of a conventional liquid crystal display. FIG. 2 is a timing chart of a circuit operation in FIG. 1. Referring to FIGS. 1 and 2 together, the liquid crystal display 100 includes a plurality of liquid crystal units. For example, the liquid crystal unit 101 includes transistors MAw11, MBw11, MAd11, MBd11, and Mr11, storage capacitors CA11 and CB11, a pixel electrode M11, and a data line CH1. The liquid crystal display 100 in a first and a second frame time displays a first and a second frames, and each of the first and the second frame time further includes a liquid crystal response time, a light display time, and a reset time. In order to accelerate the response speed of liquid crystals in grayscale transformation, a reset voltage signal Vrst is added to accelerate the transformation of liquid crystals. The reset voltage signal Vrst is delivered to a pixel electrode M11 through a transistor Mr11 in the reset time. As the coupling effect of the pixel electrode M11 and the capacitors CA11, CB11 influences the pixel signal stored in the capacitors, display brightness distortion occurs. Moreover, as the accumulation of the residual charges on the pixel electrode causes an image sticking effect, this deteriorates the display quality.

### SUMMARY OF THE INVENTION

Accordingly, the present invention is directed to providing a method for driving liquid crystal units, which is capable of removing the residual charges on the pixel electrode, so as to prevent the circuit from being influenced by a capacitive coupling effect, thereby alleviating the display brightness distortion.

The present invention is directed to providing a method for driving a liquid crystal display, so as to prevent the circuit from being influenced by the capacitive coupling effect, thereby alleviating the display brightness distortion and decreasing the image sticking effect.

The present invention is directed to providing a method for driving liquid crystal units, each including a first switch, a first capacitor corresponding to the first switch, a second switch corresponding to the first capacitor, and a pixel electrode corresponding to the second switch. The driving method includes: turning on the first switch to deliver the pixel signal to the first capacitor; providing a reset voltage to the pixel electrode, in which the reset voltage signal has a first voltage level in a first period, and a second voltage level in a second period; turning off the first switch and turning on the second switch, so as to the first capacitor is electrode electrically connected with the pixel electrode.

The present invention is directed to providing a method for driving a liquid crystal display, which includes a first and a second write-enable switches, a first and as second storage capacitors corresponding to the first and the second write-enable switches, a first and a second display-enable switches corresponding to the first and the second storage capacitors, a pixel electrode corresponding to the first and the second display-enable switches, a data line corresponding to the first and the second write-enable switches. The liquid crystal display in the first and the second frame time displays a first and a second frames, in which each of the first and the second frame time further includes a liquid crystal response time, a light display time, and a reset time.

The driving method includes: turning on the first display-enable switch to pass through the time of liquid crystal response and light display of the first frame until the reset time ended. During the liquid crystal response time and light display time of the first frame time, turn on the second write-enable switch to pre-deliver the pixel signal corresponding to the second frame to the second storage capacitor. During the reset time of the first frame time, turn on the first display-enable switch and provide the reset voltage signal to the pixel electrode by the data line while the first display-enable switch is turned on and the second display-enable switch and the second write-enable switch are turned off, in which the reset voltage signal has a first voltage level in the first period, and a second voltage level in the second period.

The present invention is further directed to providing a method for driving a liquid crystal display, which includes a first and a second write-enable switches, a first and a second storage capacitors corresponding to the first and the second write-enable switches, a first and a second display-enable switches corresponding to the first and the second storage capacitors, a pixel electrode corresponding to the first and the second display-enable switches, a data line corresponding to the first and the second write-enable switches, and a reset switch corresponding to the first and the second display-enable switches. The liquid crystal display in the first and the second frame time displays a first and a second frames, in which each of the first and the second frame time further includes a liquid crystal response time, a light display time, and a reset time.

The driving method includes: turning on the first display-enable switch to pass through the liquid crystal response time and the light display time of the first frame time until the reset time appeared. During the liquid crystal response time and light display time of the first frame time, turn on the second write-enable switch to pre-deliver the pixel signal corresponding to the second frame to the second storage capacitor. During the reset time of the first frame time, turn on the reset switch and provide the reset voltage signal to the pixel electrode while the first and the second display-enable switches and the first and the second write-enable switches are turned off, in which the reset voltage signal is a first voltage level in the first period, and a second voltage level in the second period.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a driving circuit diagram of a conventional liquid crystal display.

FIG. 2 is a timing chart of a circuit operation in FIG. 1.

FIG. 3 is a driving circuit diagram of a liquid crystal unit according to a first embodiment of the present invention.

FIG. 4 is a timing chart of FIG 3.

FIG. 5 is a driving circuit diagram of a liquid crystal display according to a second embodiment of the present invention.

FIG. 6 is a timing chart of FIG. 5.

FIG. 7 is a driving circuit diagram of a liquid crystal display according to a third embodiment of the present invention.

FIG. 8 is a timing chart of FIG. 7.

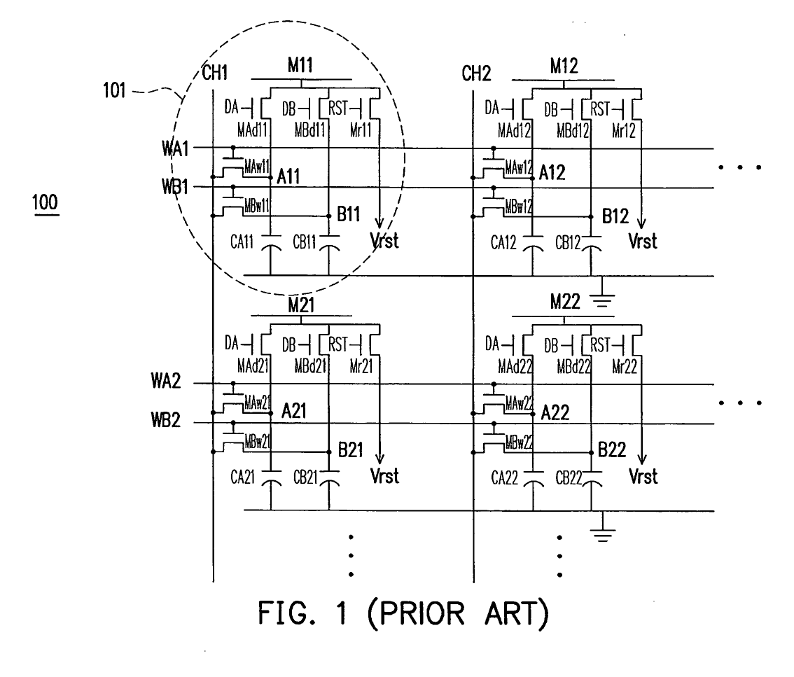

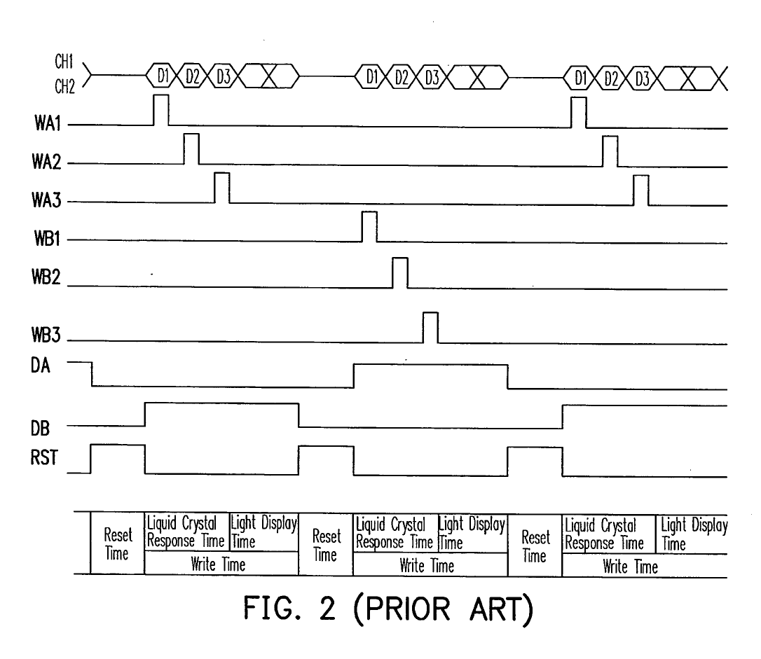

### DESCRIPTION OF EMBODIMENTS

### The First Embodiment

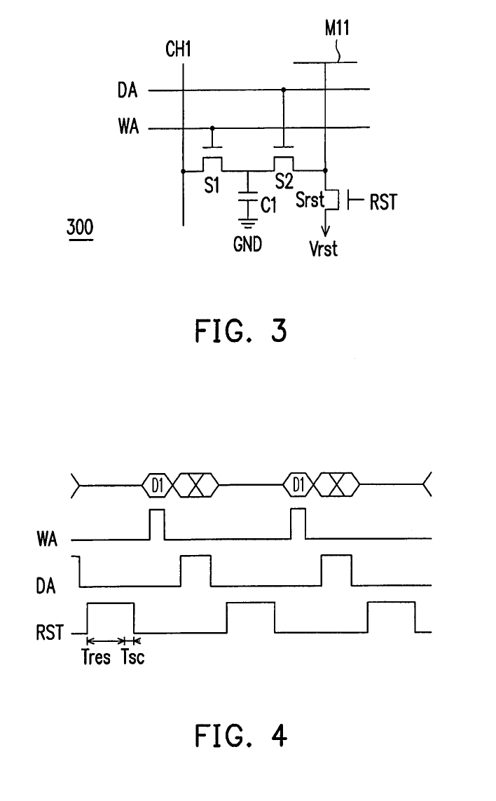

FIG. 3 is a driving circuit diagram of a liquid crystal unit according to a first embodiment of the present invention. In this embodiment, switches are implemented by transistors, and each transistor has a gate, a drain, and a source. Referring to FIG. 3, the liquid crystal unit 300 includes a first switch S1, a first capacitor C1, a second switch S2, a pixel electrode M11, and a reset switch Srst. The gate of the first switch S1 is coupled to a scan line WA, and the source is coupled to a data line CH1, and the drain is coupled to a first end of the first capacitor C1. The second end of the first capacitor C1 is coupled to a ground end GND. The gate of the second switch S2 is coupled to a display signal line DA, the source is coupled to the first end of the first capacitor C1, and the drain is coupled to the pixel electrode M11. The gate of the reset switch Srst is coupled to the reset signal line RST, the source receives a reset voltage signal Vrst, and the drain is coupled to the pixel electrode M11.

FIG. 4 is a timing chart of FIG. 3, and the following description is made with reference to FIGS. 3 and 4. First, after the reset signal line RST is enabled, the reset switch Srst is turned on and a reset voltage signal Vrst is provided to the pixel electrode M11. The reset voltage signal Vrst has a first voltage level (for example, a common voltage, which is determined according to the pixel signal) in a first period Tres (corresponding to the Tres period in the figures), and has a second voltage level (for example, set to be a ground voltage) in a second period Tsc (corresponding to the Tsc period in the figures). The residual charges on the pixel electrode M11 is removed by the reset voltage signal Vrst. After the reset signal line RST is disabled, while the voltage on the scan line WA is at a high level, the first switch S1 is turned on, so as to deliver the pixel signal to the first capacitor C1 by the data line CH1. At this time, the voltage on the display signal line DA is at a low level, so the second switch S2 is not turned on. Thereafter, when the pixel signal is stored in the first capacitor C1, the first S1 and the reset switch Srst are turned off, and the voltage on the display signal line DA is changed to be at a high level, so that second switch S2 is turned on, and the first capacitor C1 and the pixel electrode M11 are electrically connected to each other, so as to drive the pixel electrode M11 to display the pixel signal.

In this embodiment, the reset of the pixel electrode M11 and the charging of the first capacitor C1 can be performed simultaneously, and then the pixel electrode M11 is driven. Or, the first capacitor C1 is charged firstly, and then, the pixel electrode M11 is reset and the pixel electrode M11 is driven, as long as the pixel electrode M11 is reset to remove the residual charges on the pixel electrode M11 before the next pixel signal is output to the pixel electrode M11.

### The Second Embodiment

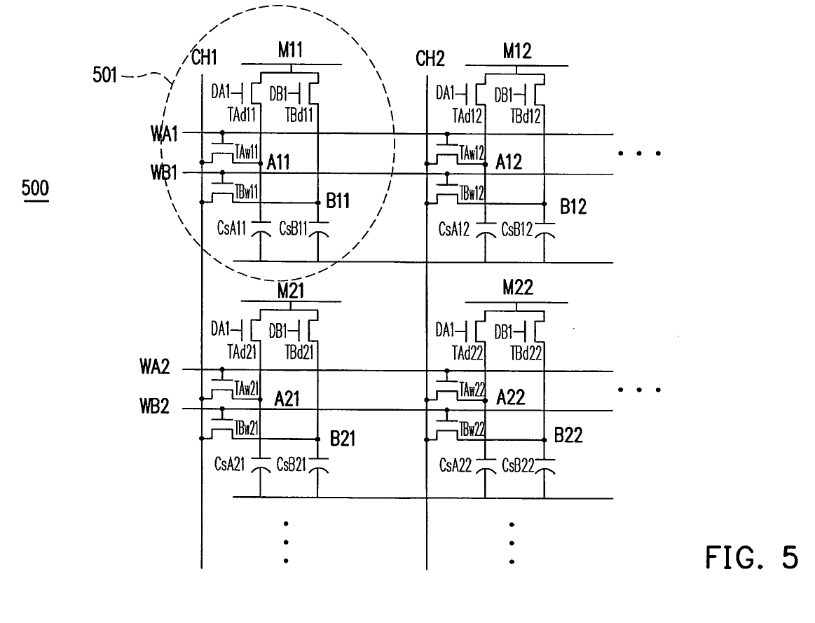

FIG. 5 is a driving circuit diagram of a liquid crystal display according to a second embodiment of the present invention. In this embodiment, switches are implemented by transistors, and each transistor has a gate, a drain, and a source. Referring to FIG. 5, the liquid crystal display 500 includes a plurality of liquid crystal units. For example, the liquid crystal unit 501 includes a first and a second write-enable switches TAw11 and TBw11, a first and a second storage capacitors CsA11 and CsB11, a first and a second display-enable switches TAd11 and TBd11, a pixel electrode M11, and a data line CH1. The liquid crystal display 500 displays a first frame and a second frame in a first and a second frame time respectively, and each of the first and the second frame time further includes a liquid crystal response time, a light display time, and a reset time.

The gate of the first write-enable switch TAw11 is coupled to a first scan line WA1, the source is coupled to the data line CH1, and the drain is coupled to a first common contact A11. The gate of the second write-enable switch TBw11 is coupled to a second scan line WB1, the source is coupled to the data line CH1, and the drain is coupled to a second common contact B11. The first end of the first storage capacitor CsA11 is coupled the first common contact A11, the second end is coupled to the ground end GND. The first end of the second storage capacitor CsB11 is coupled to the second common contact B11, the second end is coupled to a ground end GND. The gate of the first display-enable switch TAd11 is coupled to the first display signal line DA1, the source is coupled to the first common contact A11, and the drain is coupled to the pixel electrode M11. The gate of the second display-enable switch TBd11 is coupled to the second display signal line DB1, the source is coupled to the second common contact B11, and the drain is coupled to the pixel electrode M11.

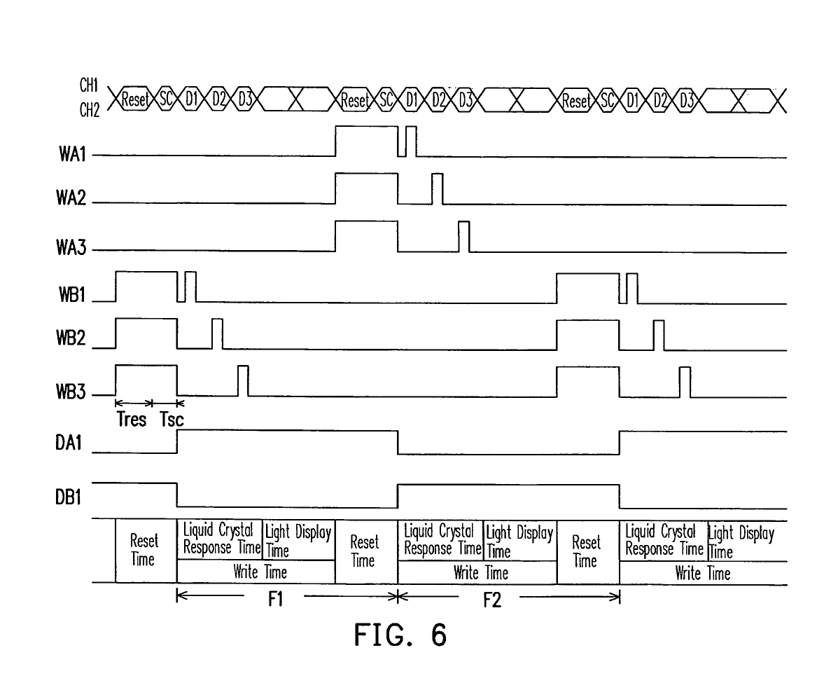

FIG. 6 is a timing chart of FIG. 5, and the following description is made with reference to FIGS. 5 and 6. During driving, taking the liquid crystal unit 501 as an example, the first storage capacitor CsA11 and the second storage capacitor CsB11 are used to alternately drive the pixel electrode M11. When the first display-enable switch TAd11 is turned on, the second storage capacitor CsB11 can be pre-charged with the next pixel signal. Whereas, when the second display-enable switch TBd11 is turned on, the first storage capacitor CsA11 can be pre-charged with the next pixel signal.

In this embodiment, a first frame time F1 and a second frame time F2 are taken as an example for illustration, and the second frame time F2 follows the first frame time F1. During the liquid crystal response time of the first frame time F1, the first write-enable switches (e.g. TAw11, TAw12, TAw21, TAw22) are first turned off and the first display signal line DA1 is enabled to turn on the first display-enable switches (e.g. TAd11, TAd12, TAd21, TAd22). The first storage capacitors (e.g. CsA11, CsA12, CsA21, CsA22) are electrically connected with the pixel electrodes (e.g. M11, M12, M21, M22) through the first display-enable switches so as to drive liquid crystals, and display the first frame in the light display time. Meanwhile, in the write time of the first frame time F1, the second scan lines (e.g. WB1, WB2) are sequentially enabled to pre-deliver the pixel signal corresponding to the second frame to the second storage capacitors (e.g. CsB11, CsB12, CsB21, CsB22) by the data lines (e.g. CH1, CH2).

During the reset time of the first frame time F1, the first display-enable switch is kept on, and the second display-enable switches (e.g. TBd11, TBd12, TBd21, TBd22) and the second write-enable switches (e.g. TBw11, TBw12, TBw21, TBw22) are turned off. At this time, the first scan lines (e.g. WA1, WA2) are enabled to deliver a reset voltage signal Vrst to the pixel electrode by the data line, so as to accelerate the transformation of liquid crystals, and remove the residual charges on the pixel electrode. The reset voltage signal Vrst has a first voltage level in the first period Tres, and a second voltage level in the second period Tsc. The first period Tres is not necessarily adjacent to the second period Tsc.

After the charges on the pixel electrode are reset, enter the second frame time F2. At this time, in the liquid crystal response time of the second frame time F2, the first display signal line DA1 is disabled and the second display signal line DB1 is enabled, so as to the second storage capacitor is electrode electrically connected with the pixel for driving liquid crystals, and the second frame is displayed in the light display time. Thereafter, the similar operation flow in the write time and the reset time in the first frame time F1 is performed. In this embodiment, two storage capacitors are used to drive the liquid crystal units, and a reset time is included in the last of each frame time, so as to reset the liquid crystal units. Furthermore, the first frame time F1 and the second frame time F2 are determined to distinguish the time sequence of frame display only, and will not be limited to such sequence.

### The Third Embodiment

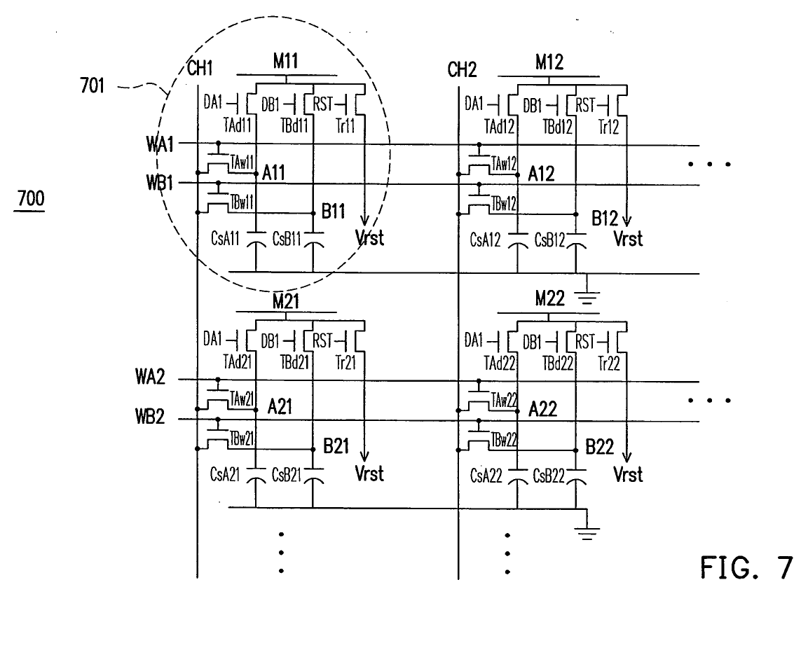

FIG. 7 is a driving circuit diagram of a liquid crystal display according to a third embodiment of the present invention. In this embodiment, switches are implemented by transistors, and each transistor has a gate, a drain, and a source. Referring to FIG. 7, the liquid crystal display 700 includes a plurality of liquid crystal units. For example, the liquid crystal unit 701 includes a first and a second write-enable switches TAw11 and TBw11, a first and a second storage capacitors CsA11 and CsB11, a first and a second display-enable switches TAd11 and TBd11, a pixel electrode M11, a data line CH1, and a reset switch Tr11. The liquid crystal display 700 in a first and a second frame time displays a first and a second frames, and each of the first and the second frame time further includes a liquid crystal response time, a light display time, and a reset time.

The gate of the first write-enable switch TAw11 is coupled to a first scan line WA1, the source is coupled to the data line CH1, and the drain is coupled to a first common contact A11. The gate of the second write-enable switch TBw1 is coupled to a second scan line WB1, the source is coupled to the data line CH1, and the drain is coupled to a second common contact B11. The first end of the first storage capacitor CsA11 is coupled the first common contact A11, the second end is coupled to the ground end GND. The first end of the second storage capacitor CsB11 is coupled to the second common contact B11, the second end is coupled to a ground end GND. The gate of the first display-enable switch TAd11 is coupled to the first display signal line DA1, the source is coupled to the first common contact A11, and the drain is coupled to the pixel electrode M11. The gate of the second display-enable switch TBd11 is coupled to the second display signal line DB1, the source is coupled to the second common contact B11, and the drain is coupled to the pixel electrode M11. The gate of the reset switch Tr11 is coupled to the reset signal line RST, the source receives a reset voltage signal Vrst, and the drain is coupled to the pixel electrode M11.

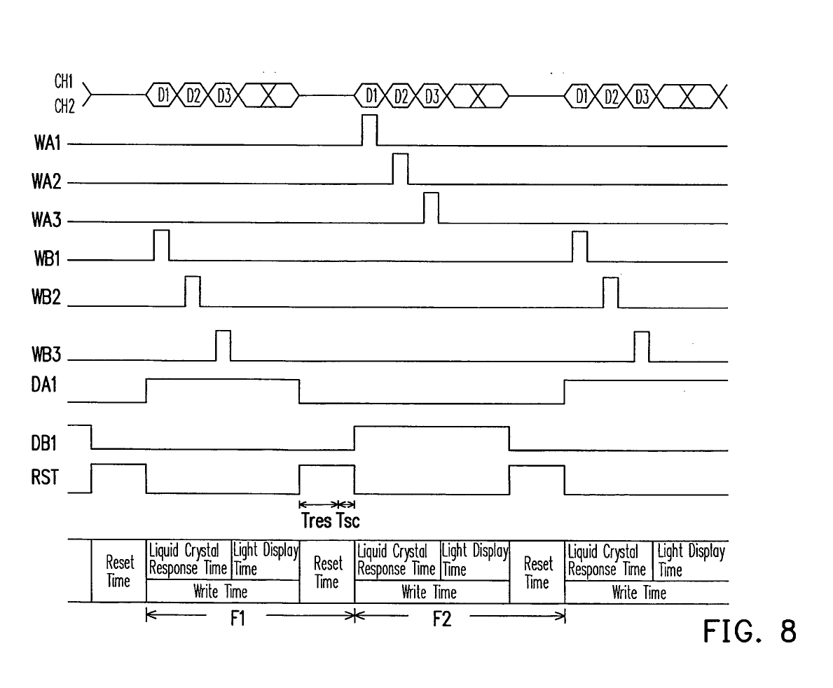

FIG. 8 is a timing chart of FIG. 7, and the following description is made with reference to FIGS. 7 and 8. During driving, taking the liquid crystal unit 701 as an example, the first storage capacitor CsA11 and the second storage capacitor CsB11 are used to alternately drive the pixel electrode M11. When the first display-enable switch TAd11 is turned on, the second storage capacitor CsB11 can be pre-charged with the next pixel signal. Whereas, when the second display-enable switch TBd11 is turned on, the first storage capacitor CsA11 can be pre-charged with the next pixel signal.

In this embodiment, a first frame time F1 and a second frame time F2 are taken as example for illustration, and the second frame time F2 follows the first frame time F1. During the liquid crystal response time of the first frame time F1, the first write-enable switches (e.g. TAw11, TAw12, TAw21, TAw22) are first turned off and the first display signal line DA1 is enabled to turn on the first display-enable switches (e.g. TAd11, TAd12, TAd21, TAd22). The first storage capacitors (e.g. CsA11, CsA12, CsA21, CsA22) are electrically connected with the pixel electrodes (e.g. M11, M12, M21, M22) through the first display-enable switches to drive liquid crystals, and display the first frame in the light display time. Meanwhile, in the write time of the first frame time F1, the second scan lines (e.g. WB1, WB2) are sequentially enabled to pre-deliver the pixel signal corresponding to the second frame to the second storage capacitors (e.g. CsB11, CsB12, CsB21, CsB22) by the data lines (e.g. CH1, CH2).

During the reset time of the first frame time F1, the first display-enable switch, the first write-enable switch, the second display-enable switches (e.g. TBd11, TBd12, TBd21, TBd22) and the second write-enable switches (e.g. TBw11, TBw12, TBw21, TBw22) are turned off. At this time, the reset signal line RST is enabled to turn on the reset switches (e.g. Tr11, Tr12, Tr21, Tr22) and deliver a reset voltage signal Vrst to the pixel electrode through the reset switches, so as to accelerate the transformation of liquid crystals, and remove the residual charges on the pixel electrode. The reset voltage signal Vrst has a first voltage level in the first period Tres, and a second voltage level in the second period Tsc. The first period Tres is not necessarily adjacent to the second period Tsc.

After the charges on the pixel electrode are reset, enter the second frame time F2. At this time, in the liquid crystal response time of the second frame time F2, the first display signal line DA1 is disabled and the second display signal line DB1 is enabled, so as to the second storage capacitor is electrically connected with the pixel electrode for driving the liquid crystals, and the second frame is displayed in the light display time. Thereafter, the similar operation flow in the write time and the reset time in the first frame time F1 is performed. In this embodiment, two storage capacitors are used to alternately drive the liquid crystal units, and a reset time is included in the last of each frame time, so as to reset the liquid crystal units. Furthermore, the first frame time F1 and the second frame time F2 are determined to distinguish the time sequence of frame display only, and will not be limited to such sequence.

Comparing the embodiment and the conventional circuit, the reset voltage signal Vrst has a first voltage level (e.g. a common voltage or a dark state voltage) in the first period Tres according to the above embodiment, and a second voltage level (e.g. a ground voltage) in the second period Tsc, in which the first period Tres is not necessarily adjacent to the second period Tsc. In this way, the response speed of liquid crystals can be accelerated in the first period Tres, and the residual charges on the pixel electrode can be removed in the second period Tsc. The reset voltage signal Vrst of the conventional circuit can merely accelerate the response speed of liquid crystals, and the display brightness is distorted because the pixel signal stored in the capacitors is influenced by the capacitive coupling effect. Obviously, the driving method of the present invention can effectively eliminate the capacitive coupling effect and remove the residual charges in the pixel capacitors. Therefore, the brightness of the display can be resumed and the image sticking effect caused by the charge accumulation can be alleviated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for driving a liquid crystal unit, the liquid crystal unit comprising a first switch, a first capacitor corresponding to the first switch, a second switch corresponding to the first capacitor, and a pixel electrode corresponding to the second switch, the driving method comprising:
turning on the first switch to deliver a pixel signal to the first capacitor;
providing a reset voltage signal to the pixel electrode, wherein the reset voltage signal has a first voltage level during a first period and a second voltage level during a second period; and
turning off the first switch and turning on the second switch, so as to the first capacitor electrically connected with the pixel electrode.

2. The driving method of claim 1, wherein the second period is shorter than the first period.

3. The driving method of claim 1, wherein the first voltage level is determined according to the pixel signal.

4. The driving method of claim 1, wherein the first voltage level is set to be a common voltage.

5. The driving method of claim 1, wherein the second voltage level is set to be a ground voltage.

6. The driving method of claim 1, wherein the reset voltage signal is provided through a reset switch.

7. The driving method of claim 6, wherein the first period and the second period are discontinuous.

8. A method for driving a liquid crystal display, the liquid crystal display comprising a first and a second write-enable switches, a first and a second storage capacitors corresponding to the first and the second write-enable switches, a first and a second display-enable switches corresponding to the first and the second storage capacitors, a pixel electrode corresponding to the first and the second display-enable switches, and a data line corresponding to the first and the second write-enable switches, wherein the liquid crystal display displays a first and a second frames respectively in a first and a second frame time, wherein each of the first and the second frame times further comprises a liquid crystal response time, a light display time, and a reset time, the driving method comprising:
(a) turning on the first display-enable switch to pass through the liquid crystal response time and the light display time of the first frame until the reset time ended;
(b) turning on a second write-enable switch to pre-deliver a pixel signal corresponding to a second frame to the second storage capacitor during the liquid crystal response time and light display time of the first frame time; and
(c) during the reset time of the first frame time, turning on the first write-enable switch and providing a reset voltage signal to the pixel electrode by the data line while the first display-enable switch is turned on and the second display-enable switch and the second write-enable switch are turned off, wherein the reset voltage signal has a first voltage level during a first period, and a second voltage level during a second period.

9. The driving method of claim 8, wherein the first voltage level is determined according to the pixel signal.

10. The driving method of claim 8, wherein the first voltage level is set to be a common voltage.

11. The driving method of claim 8, wherein the second voltage level is set to be a ground voltage.

12. The driving method of claim 8, wherein the second period is shorter than the first period.

13. A method for driving a liquid crystal display, the liquid crystal display comprising a first and a second write-enable switches, a first and a second storage capacitors corresponding to the first and the second write-enable switches, a first and a second display-enable switches corresponding to the first and the second storage capacitors, a pixel electrode corresponding to the first and the second display-enable switches, and a data line corresponding to the first and the second write-enable switches, a reset switch corresponding to the first and the second display-enable switches, wherein the liquid crystal display displays a first and a second frames respectively during a first and a second frame time, wherein each of the first and the second frame times further comprises a liquid crystal response time, a light display time, and a reset time, the driving method comprising:
(a) turning on the first display-enable switch to pass through the liquid crystal response time and light display time of the first frame until the reset time appeared;
(b) turning on a second write-enable switch to pre-deliver a pixel signal corresponding to a second frame to a second storage capacitor during the liquid crystal response time and the light display time of the first frame time; and
(c) during the reset time of the first frame, turning on the reset switch and providing a reset voltage signal to the pixel electrode while the first and the second display-enable switches and the first and the second write-enable switches are turned off, wherein the reset voltage signal has a first voltage level during a first period, and a second voltage level during a second period.

14. The driving method of claim 13, wherein the first voltage level is determined according to the pixel signal.

15. The driving method of claim 13, wherein the first voltage level is set to be a common voltage.

16. The driving method of claim 13, wherein the second voltage level is set to be a ground voltage.

17. The driving method of in claim 13, wherein the second period is shorter than the first period.
